(19) United States
(12) Patent Application Publication
(10) Pub. No.: US 2016/0241021 A1
(43) Pub. Date: Aug. 18, 2016

(54) ELECTROSTATIC DISCHARGE PROTECTION DEVICE

(71) Applicant: MACRONIX International Co., Ltd., Hsinchu (TW)

(72) Inventors: Shih-Yu Wang, Hsinchu (TW); Chieh-Wei He, Hsinchu (TW); Yao-Wen Chang, Hsinchu (TW); Tao-Cheng Lu, Hsinchu (TW)

(21) Appl. No.: 14/624,409

(22) Filed: Feb. 17, 2015

(51) Int. Cl. H02H 9/04

(52) U.S. Cl. CPC H02H 9/04

(57) ABSTRACT

An electrostatic discharge protection device that includes a plurality of voltage drop elements, an impedance element, a driving circuit, and a clamping circuit is provided. The voltage drop elements are electrically connected in series between a first line and a node, and the voltage drop elements are configured to define an activating voltage. If a signal from the first line is greater than the activating voltage, the voltage drop elements conduct the first line to the node in response to the signal from the first line. The impedance element is electrically connected between the node and a second line. The driving circuit amplifies a control signal from the node and accordingly generates a driving signal. The clamping circuit determines whether to generate a discharging path between the first line and the second line according to the driving signal.

### FIELD OF THE INVENTION

The invention relates to a protection device; more particularly, the invention relates to an electrostatic discharge (ESD) protection device.

### DESCRIPTION OF RELATED ART

Integrated circuits are often equipped with electrostatic discharge (ESD) protection devices to prevent damages caused by ESD. Nevertheless, during the normal operation of the integrated circuit, the existing ESD protection device is frequently mis-triggered by noise, and the integrated circuit is influenced by the ESD protection device. Hence, how to design an ESD protection device capable of avoiding false triggering has become a challenge to various manufacturers.

### SUMMARY OF THE INVENTION

The invention is directed to an electrostatic discharge (ESD) protection device, in which plural voltage drop elements are connected in series so as to avoid false triggering of the ESD protection device.

In an embodiment of the invention, an ESD protection device includes a plurality of voltage drop elements, an impedance element, a driving circuit, and a clamping circuit. The voltage drop elements are electrically connected in series between a first line and a node, and the voltage drop elements are configured to define an activating voltage. If a signal from the first line is greater than the activating voltage, the voltage drop elements conduct the first line to the node in response to the signal from the first line. The impedance element is electrically connected between the node and a second line. The driving circuit amplifies a control signal from the node and accordingly generates a driving signal. The clamping circuit determines whether to generate a discharging path between the first line and the second line according to the driving signal.

In another embodiment of the invention, an ESD protection device includes a plurality of voltage drop elements, an impedance element, a driving circuit, a clamping circuit, and a latch circuit. The voltage drop elements are connected in series between a first line and a node. The impedance element is electrically connected between the node and a second line. The driving circuit amplifies a control signal from the node and accordingly generating a driving signal. The clamping circuit determines whether to generate a discharging path between the first line and the second line according to the driving signal. The latch circuit is electrically connected to the node and the driving circuit. If the voltage drop elements are turned on, the latch circuit latches the control signal to a predetermined level, such that the clamping circuit generates the discharge path.

In view of the above, in the ESD protection device provided herein, the voltage drop elements connected in series are configured to define the activating voltage, and the signal from the first line need be greater than the activating voltage so that the first line could be conducted to the node. Besides, the driving circuit drives the clamping circuit according to the control signal from the node. Through the voltage drop elements connected in series, the false triggering of the ESD protection device can be avoided.

Several exemplary embodiments accompanied with figures are described in detail below to further describe the invention in details.

### BRIEF DESCRIPTION OF THE DRAWINGS

FIG. 1 is a schematic view illustrating an electrostatic discharge (ESD) protection device according to an embodiment of the invention.

FIG. 2 is a schematic view simulating a buffer signal output by a first inverter under normal operation according to an embodiment of the invention.

FIG. 3 is a schematic view simulating a buffer signal output by a first inverter under an ESD test according to an embodiment of the invention.

FIG. 4 is a schematic view illustrating an ESD protection device according to another embodiment of the invention.

FIG. 5 is a schematic view illustrating waveforms of an ESD protection device according to an embodiment of the invention.

FIG. 6 is a schematic view illustrating an ESD protection device according to another embodiment of the invention.

FIG. 7 is a schematic view illustrating an ESD protection device according to another embodiment of the invention.

### DETAILED DESCRIPTION OF DISCLOSED EMBODIMENTS

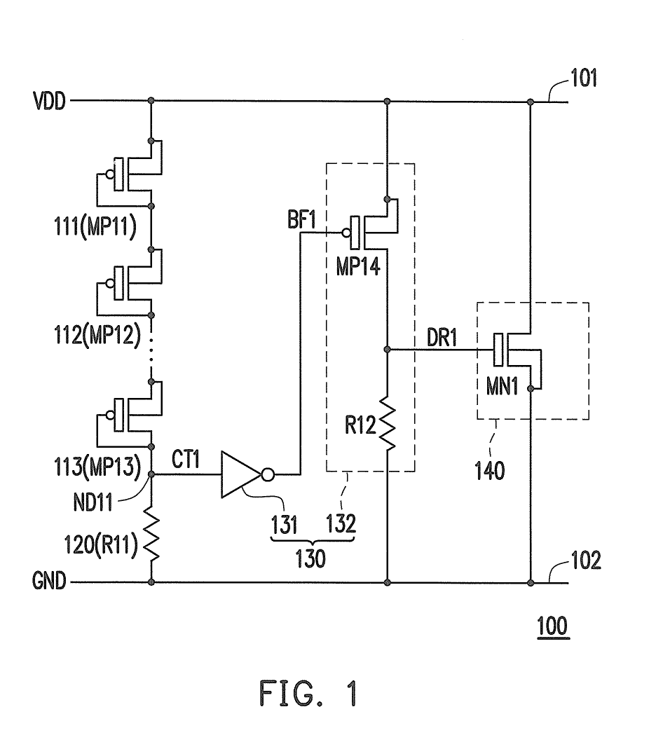

FIG. 1 is a schematic view illustrating an electrostatic discharge (ESD) protection device according to an embodiment of the invention. With reference to FIG. 1, the ESD projection device 100 includes a plurality of voltage drop elements 111 to 113, an impedance element 120, a driving circuit 130, and a clamping circuit 140. The voltage drop elements 111 to 113 are connected in series between a first line 101 and a node ND11. The impedance element 120 is electrically connected between the node ND11 and a second line 102. The driving circuit 130 is electrically connected to the node ND11, and the clamping circuit 140 is electrically connected to the driving circuit 130.

The impedance element 120 may be a resistor R11, for instance. Besides, in response to the signal from the first line 101, the voltage drop elements 111 to 113 determine whether to conduct the first line 101 to the node ND11. For instance, each of the voltage drop elements may be constituted by a PMOS transistor. As shown in FIG. 1, the voltage drop elements 111 to 113 may be constituted by the PMOS transistors MP11 to MP13. Besides, a source of each of the PMOS transistors MP11 to MP13 is directly or indirectly connected to the first line 101, and a gate and a drain of each of the PMOS transistors MP11 to MP13 are electrically connected to the node ND11.

Regarding one single voltage drop element (e.g., one PMOS transistor), if the signal applied to the voltage drop element is greater than a threshold voltage (e.g., the threshold voltage of the PMOS transistor), the voltage drop element is turned on, and the voltage drop generated by the voltage drop element becomes equal to the threshold voltage. By contrast, as to the voltage drop elements 111 to 113 that are serially connected, i.e., as to N voltage drop elements that are serially connected, if the signal applied to the voltage drop elements 111 to 113 are greater than N times the threshold voltage, the N voltage drop elements are turned on and further conduct the first line 101 to the node ND11. Here, N is a positive integer larger than 1.

However, if the signal applied to the voltage drop elements 111 to 113 are less than or equal to N times the threshold voltage, the N voltage drop elements are turned off and thus cannot conduct the first line 101 to the node ND11. That is, the ESD protection device 100 can define an activating voltage through the voltage drop elements connected in series. The activating voltage is proportional to the number N of the serially connected voltage drop elements 111 to 113; that is, the activating voltage is equal to N times the threshold voltage. Besides, if a signal from the first line 101 is greater than the activating voltage, the voltage drop elements 111 to 113 conduct the first line 101 to the node ND11 in response to the signal from the first line 101.

A control signal CT1 at the node ND11 is switched to different voltage levels in response to the status of the voltage drop elements 111 to 113. The driving circuit 130 amplifies the control signal CT1 from the node ND11 and accordingly generates a driving signal DR1. For instance, the driving circuit 130 includes inverters 131 and 132. An input terminal of the inverter 131 receives the control signal CT1. An input terminal of the inverter 132 is electrically connected to an output terminal of the inverter 131, and an output terminal of the inverter 132 is configured to generate the driving signal DR1.

To be specific, the inverter 132 includes a PMOS transistor MP14 and a resistor R12. A source of the PMOS transistor MP14 is electrically connected to the first line 101, a gate of the PMOS transistor MP14 is electrically connected to the output terminal of the inverter 131, and a drain of the PMOS transistor MP14 is configured to generate the driving signal DR1. The resistor R12 is electrically connected between the drain of the PMOS transistor MP14 and the second line 102. During operation, the driving circuit 130 may amplify the control signal CT1 through the inverters 131 and 132 and accordingly generate the driving signal DR1.

The clamping circuit 140 determines whether to generate a discharging path between the first line 101 and the second line 102 according to the driving signal DR1. For instance, the clamping circuit 140 includes an NMOS transistor MN1. A drain of the NMOS transistor MN1 is electrically connected to the first line 101, a gate of the NMOS transistor MN1 is electrically connected to the output terminal of the inverter 132, and a source of the NMOS transistor MN1 is electrically connected to the second line 102. During operation, the NMOS transistor MN1 controls the connection between the drain and the source of the NMOS transistor MN1 according to the driving signal DR1. When the NMOS transistor MN1 conducts its drain and source, the NMOS transistor MN1 is able to generate the discharging path between the first line 101 and the second line 102.

In an actual application, the ESD protection device 100 can guide the electrostatic pulse coming from the first line 101, so as to prevent the electrostatic pulse from causing damages to an integrated circuit (not shown). For instance, if an ESD event occurs, the electrostatic pulse occurs on the first line 101. At this time, in response to the electrostatic pulse from the first line 101, the voltage drop elements 111 to 113 are turned on and further conduct the first line 101 to the node ND11. The control signal CT1 at the node ND11 is correspondingly pulled up to a high level.

The two inverters 131 and 132 in the driving circuit 130 invert the control signal CT1 twice and thereby generate the drive signal DR1 with the high level. According to the drive signal DR1 with the high level, the NMOS transistor MN1 conducts its drain and source and further generates the discharging path between the first line 101 and the second line 102. Thereby, the electrostatic pulse from the first line 101 may be guided to the second line 102 through the discharging path, such that the electrostatic pulse can be prevented from causing damages to the integrated circuit.

On the other hand, when the integrated circuit operates normally, the first line 101 can serve to transmit the power voltage VDD, and the second line 102 can serve to transmit the ground voltage GND. Besides, the power voltage VDD is smaller than or equal to the activating voltage defined by the voltage drop elements 111 to 113. Hence, the voltage drop elements 111 to 113 are not turned on, and thereby the first line 101 cannot be conducted to the node ND11. The control signal CT1 at the node ND11 is correspondingly pulled down to a low level through the impedance element 120, such that the driving circuit 130 generates the driving signal DR1 with the low level. According to the drive signal DR1 with the low level, the NMOS transistor MN1 disconnects the connection between its drain and source, and therefore the discharging path cannot be generated between the first line 101 and the second line 102. Thereby, once the integrated circuit operates normally, the integrated circuit can be protected from being affected by the ESD protection apparatus 100.

The power noise in the integrated circuit may also occur on the first line 101. However, the power noise need be greater than the activating voltage defined by the voltage drop elements 111 to 113 so that the clamping circuit 140 could generate the discharging path. That is, through the voltage drop elements 111 to 113 connected in series, the false triggering of the ESD protection device 100 can be avoided. Note that people having ordinary skill in the art may adjust the number N of the serially connected voltage drop elements 111 to 113 based on actual design requirements and thereby raise the activating voltage and increase the anti-interference ability to avoid false triggering.

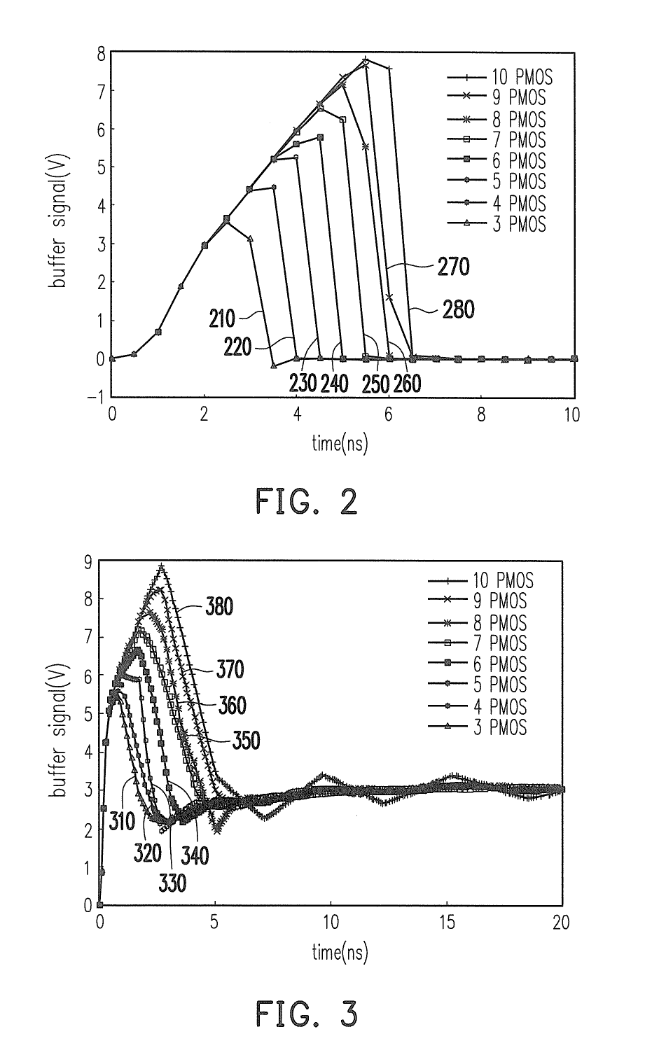

FIG. 2 is a schematic view simulating a buffer signal output by a first inverter under normal operation according to an embodiment of the invention. The voltage drop elements 111 to 113 may be constituted by a plurality of PMOS transistors connected in series. If the number of the serially connected PMOS transistors is three, the buffer signal BF1 output by the inverter 131 in response to the increasing power voltage VDD is shown by the curve 210. Similarly, curves 220 to 280 respectively show the buffer signal BF1 output by the inverter 131 if the number of the serially connected PMOS transistors is four to ten.

As indicated by the curve 210, if the number of the serially connected voltage drop elements is 3, the activating voltage is approximately equal to 3.5 volts. Hence, when the power voltage VDD gradually increases to 3.5 volts, the voltage drop elements are not conducted, such that the control signal CT1 is pulled down to a low level. Through the inverter 131, the control signal CT1 is inverted to a high level (i.e., the power voltage VDD). Hence, when the power voltage VDD gradually increases to 3.5 volts, the buffer signal BF1 gradually increases to 3.5 volts as well.

In another aspect, as shown by the curve 210, if the power voltage VDD is greater than 3.5 volts, the voltage drop elements are conducted, such that the control signal CT1 is pulled up to a high level. Through the inverter 131, the control signal CT1 is inverted to a low level (i.e., the ground voltage GND). Hence, if the power voltage VDD is greater than 3.5 volts, the buffer signal BF1 is kept on the ground voltage GND. Similarly, as indicated by the curve 220, if the number of the serially connected voltage drop elements (i.e., the PMOS transistors) is 4, the activating voltage is approximately equal to 4.5 volts. Therefore, the buffer signal BF1 output by the inverter 131 gradually increases to 4.5 volts and is then pulled down to the ground voltage. Namely, it can be derived from the variation tendency of the curves 210 to 280 that the activating voltage is increased together with an increase in the number of the serially connected voltage drop elements. Therefore, by adjusting the number of the serially connected voltage drop elements, the ability to avoid false triggering of the ESD protection device 100 can be increased.

Besides, the trigger voltage of the ESD protection device 100 is also increased together with the increase in the number of the serially connected voltage drop elements. FIG. 3 is a schematic view simulating a buffer signal output by a first inverter under an ESD test according to an embodiment of the invention. In the testing environment as provided in FIG. 3, the electrostatic pulse in a human body model (HBM) is supplied to the first line 101, and the voltage drop elements 111 to 113 are constituted by a plurality of PMOS transistors connected in series. Curves 310 to 380 respectively show the buffer signal BF1 output by the inverter 131 in response to the electrostatic pulse if the number of the serially connected PMOS transistors is three to ten. It can be derived from the variation tendency of the curves 310 to 380 that the trigger voltage of the ESD protection device 100 is increased together with an increase in the number of the serially connected voltage drop elements. For instance, if the number of the PMOS transistors is ten, the trigger voltage of the ESD protection device 100 may be raised to 9 volts approximately.

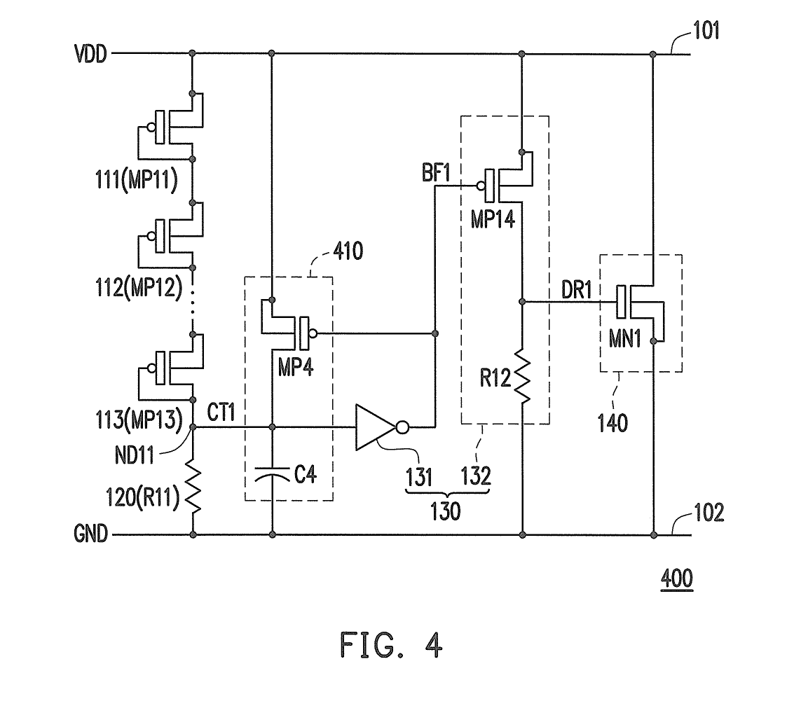

FIG. 4 is a schematic view illustrating an ESD protection device according to another embodiment of the invention. The ESD protection device 400 depicted in FIG. 4 is similar to the ESD protection device 100 illustrated in FIG. 1, and thus the same or similar reference numbers shown in FIG. 1 and FIG. 4 represent the same or similar elements. The difference between the embodiment shown in FIG. 4 and that shown in FIG. 1 lies in that the ESD protection device 500 depicted in FIG. 4 includes a latch circuit 410.

Particularly, the latch circuit 410 is electrically connected to the node ND11 and the driving circuit 130. When the first line 101 is conducted to the node ND11, the latch circuit 410 latches the control signal CT1 to a predetermined level, such that the clamping circuit 140 generates the discharge path. For instance, the latch circuit 410 includes a PMOS transistor MP4 and a capacitor C4. A source of the PMOS transistor MP4 is electrically connected to the first line 101, a gate of the PMOS transistor MP4 is electrically connected to an output terminal of the inverter 131, and a drain of the PMOS transistor MP4 is electrically connected to an input terminal of the inverter 131. A first terminal of the capacitor C4 is electrically connected to the drain of the PMOS transistor MP4, and a second terminal of the capacitor C4 is electrically connected to the second line 102.

During operation, if the voltage drop elements 111 to 113 are turned on in response to an ESD event, the control signal CT1 is pulled up to a high level, and the capacitor C4 is then charged. Besides, the PMOS transistor MP4 and the inverter 131 form a feedback mechanism, and the control signal CT1 is latched to the predetermined level (e.g., the high level) through the feedback mechanism. In other words, if the voltage drop elements 111 to 113 are turned on, the latch circuit 410 latches the control signal CT1 to a predetermined level. The driver circuit 130 can then generate the driving signal DR1 with the high level, such that the clamping circuit 140 generates the discharging path. Thereby, the protection capability of the ESD protection device 400 can be improved. On the other hand, if the voltage drop elements 111 to 113 are turned off, the latch circuit 410 does not latch the control signal CT1.

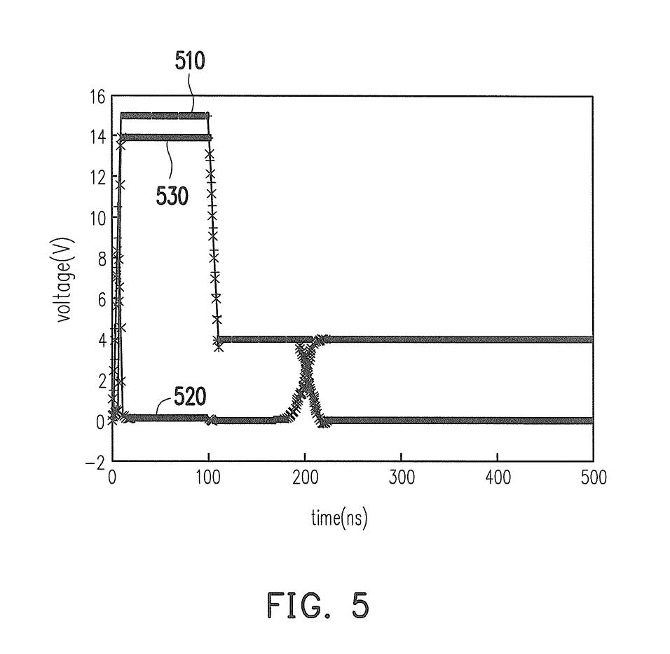

FIG. 5 is a schematic view illustrating waveforms of an ESD protection device according to an embodiment of the invention. FIG. 5 illustrates the waveforms of the ESD protection device 400 in the situation that the PMOS transistor MP4 of the latch circuit 410 is removed. Besides, in FIG. 5, the curve 510 represents the power voltage VDD supplied to the first line 101, the curve 520 represents the buffer signal BF1 output by the inverter 131, and the curve 530 represents the driving signal DR1 output by the inverter 132. As shown in FIG. 5, if the power voltage VDD is kept on 15 volts, the voltage drop elements 111 to 113 are turned on. At this time, the control signal CT1 is pulled up to a high level, and the latch circuit 410 latches the control signal CT1 to the predetermined level (e.g., the high level). Thereby, as shown by the curves 520 and 530, the buffer signal BF1 can be kept on a low level, and the driving signal DR1 can be kept on a high level (e.g., approaching the power voltage VDD).

Besides, if the power voltage VDD is switched to 4 volts, the control signal CT1 is kept on the high level for a period of time through the charging and discharging of the capacitor C4 and is then switched to the low level. By contrast, as shown by the curve 520, during the early stage when the power voltage VDD is switched to 4 volts, the buffer signal BF1 can be kept on the low level. Thereby, as shown by the curve 530, the driving signal DR1 can still remain on the high level (e.g., approaching the power voltage VDD) so that the time for generating the discharging path by the clamping circuit 140 can be extended to 200 ns.

It should be noted that the buffer signal BF1 can be continuously kept on the low level through the feedback mechanism formed by the PMOS transistor MP4 and the inverter 131 when the PMOS transistor MP4 of the latch circuit 410 is not removed. Thereby, during the stage when the power voltage VDD is switched to 4 volts, the driving signal DR1 can continuously remain on the high level so that the time for generating the discharging path by the clamping circuit 140 can be longer than 200 ns. The detailed descriptions of other elements shown in FIG. 4 are included in the above-mentioned embodiments and thus are not repeated herein.

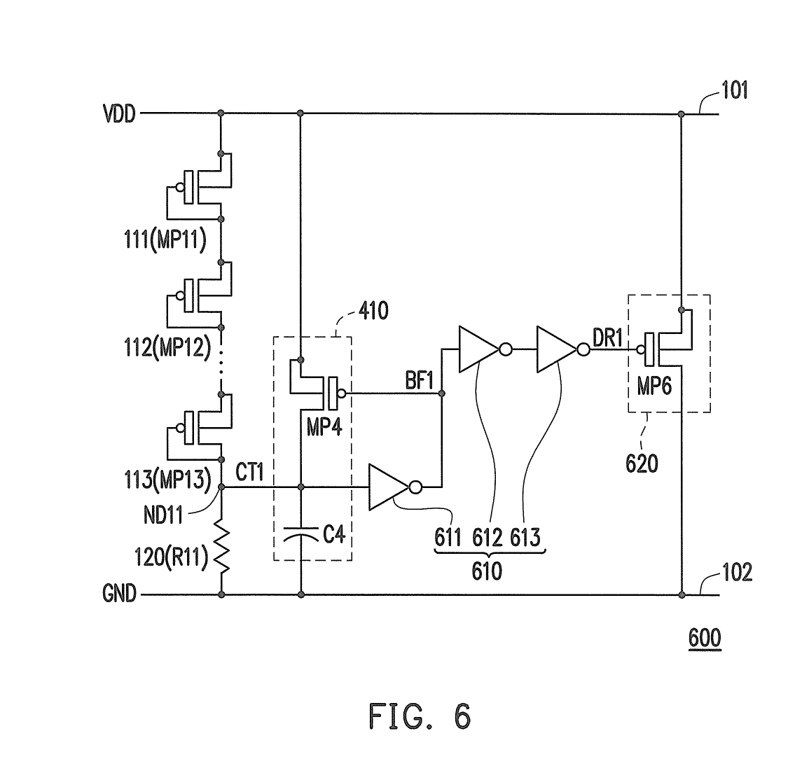

FIG. 6 is a schematic view illustrating an ESD protection device according to another embodiment of the invention. The ESD protection device 600 depicted in FIG. 4 is similar to the ESD protection device 400 illustrated in FIG. 4, and thus the same or similar reference numbers shown in FIG. 4 and FIG. 6 represent the same or similar elements. The difference between the embodiment shown in FIG. 6 and that shown in FIG. 4 lies in that the driving circuit 610 depicted in FIG. 6 includes odd-numbered inverters 611 to 613, and the clamping circuit 620 includes the PMOS transistor MP6.

Specifically, the odd-numbered inverters 611 to 613 are connected in series between the node ND11 and the clamping circuit 620. The first inverter 611 among the odd-numbered inverters 611 to 613 receives the control signal CT1, and the last inverter 613 among the odd-numbered inverters 611 to 613 generates the driving signal DR1. A source of the PMOS transistor MP6 is electrically connected to the first line 101, a gate of the PMOS transistor MP6 is electrically connected to an output terminal of the last inverter 613 among the odd-numbered inverters 611 to 613, and a drain of the PMOS transistor MP6 is electrically connected to the second line 102.

Namely, the clamping circuit 620 may be constituted by the PMOS transistor MP6. The driving circuit 610 may drive the PMOS transistor MP6 by the odd-numbered inverters 611 to 613. When an ESD event occurs, the control signal CT1 at the node ND11 is pulled up to a high level, and the driving circuit 610 can generate the driving signal DR1 with a low level by means of odd-numbered inverters 611 to 613. According to the drive signal DR1 with the low level, the PMOS transistor MP6 generates the discharging path between the first line 101 and the second line 102. Thereby, the electrostatic pulse from the first line 101 may be guided to the second line 102 through the discharging path, such that the electrostatic pulse can be prevented from causing damages to the integrated circuit.

From another perspective, if the integrated circuit operates normally, the control signal CT1 at the node ND11 is pulled down to a low level by the impedance element 120, and the driving circuit 610 can generate the driving signal DR1 at a high level by means of odd-numbered inverters 611 to 613. According to the drive signal DR1 at the high level, the PMOS transistor MP6 disconnects the discharging path between the first line 101 and the second line 102. Thereby, once the integrated circuit operates normally, the integrated circuit can be protected from being affected by the ESD protection apparatus 100. The detailed descriptions of other elements shown in FIG. 6 are included in the above-mentioned embodiments and thus are not repeated herein.

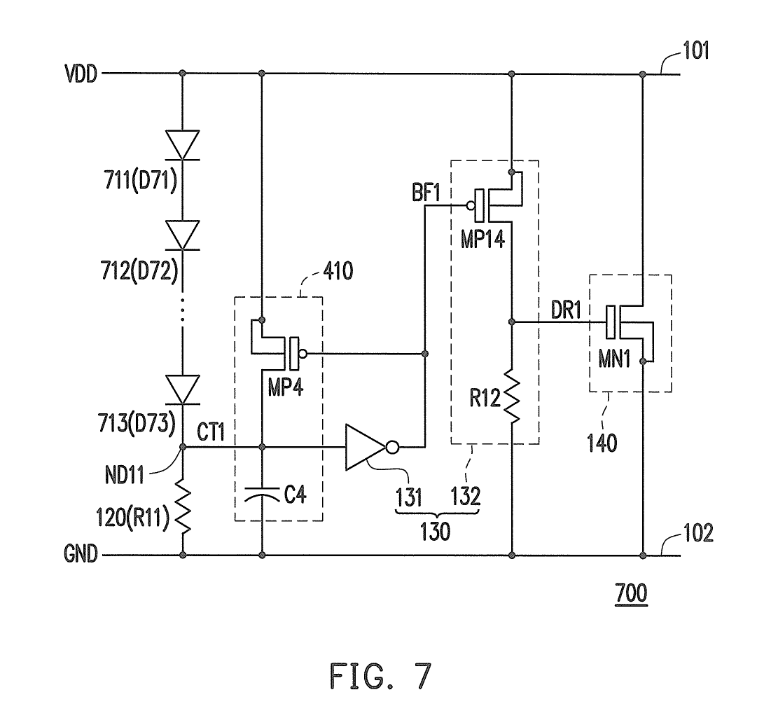

FIG. 1 exemplifies several ways to implement the voltage drop elements 111 to 113, which should however be construed as limitations to the invention. For instance, each of the voltage drop elements 111 to 113 shown in FIG. 1, FIG. 4, and FIG. 6 may be constituted by a diode. FIG. 7 is a schematic view illustrating an ESD protection device according to another embodiment of the invention. The ESD protection device 700 depicted in FIG. 7 is similar to the ESD protection device 400 illustrated in FIG. 4. The difference between the embodiment shown in FIG. 7 and that shown in FIG. 4 lies in that the voltage drop elements 711 to 713 depicted in FIG. 7 are constituted by the diodes D71 to D73. Besides, an anode of each of the diodes D71 to D73 is electrically connected to the first line 101, and a cathode of each of the diodes D71 to D73 is electrically connected to the node ND11. The detailed descriptions of other elements shown in FIG. 7 are included in the above-mentioned embodiments and thus are not repeated herein.

To sum up, in the ESD protection device provided herein, the voltage drop elements connected in series are configured to define the activating voltage, and the signal coming from the first line need be greater than the activating voltage so that the first line could be conducted to the node. Besides, the driving circuit drives the clamping circuit according to the control signal coming from the node. Through the voltage drop elements connected in series, the false triggering of the ESD protection device can be avoided. Moreover, the ability to avoid false triggering of the ESD protection device described herein can be increased by adjusting the number of the serially connected voltage drop elements.

Although the invention has been described with reference to the above embodiments, it will be apparent to one of ordinary skill in the art that modifications to the described embodiments may be made without departing from the spirit of the invention. Accordingly, the scope of the invention will be defined by the attached claims and not by the above detailed descriptions.

What is claimed is:

1. An electrostatic discharge protection device comprising:
a plurality of voltage drop elements connected in series between a first line and a node and configured to define an activating voltage, wherein if a signal from the first line is greater than the activating voltage, the voltage drop elements conduct the first line to the node in response to the signal from the first line;
an impedance element electrically connected between the node and a second line;
a driving circuit amplifying a control signal from the node and accordingly generating a driving signal; and
a clamping circuit determining whether to generate a discharging path between the first line and the second line according to the driving signal.

2. The electrostatic discharge protection device according to claim 1, further comprising:
a latch circuit electrically connected to the node and the driving circuit, wherein when the first line is conducted to the node, the latch circuit latches the control signal to a predetermined level, such that the clamping circuit generates the discharge path.

3. The electrostatic discharge protection device according to claim 2, wherein the driving circuit receives the control signal through an inverter, and the latch circuit comprises:
a PMOS transistor, a source of the PMOS transistor being electrically connected to the first line, a gate of the PMOS transistor being electrically connected to an output terminal of the inverter, a drain of the PMOS transistor being electrically connected to an input terminal of the inverter; and
a capacitor, a first terminal of the capacitor being electrically connected to the drain of the PMOS transistor, a second terminal of the capacitor being electrically connected to the second line.

4. The electrostatic discharge protection device according to claim 1, wherein each of the voltage drop elements is constituted by a PMOS transistor, a source of the PMOS transistor is electrically connected to the first line, and a gate and a drain of the PMOS transistor are electrically connected to the node.

5. The electrostatic discharge protection device according to claim 1, wherein each of the voltage drop elements is constituted by a diode, an anode of the diode is electrically connected to the first line, and a cathode of the diode is electrically connected to the node.

6. The electrostatic discharge protection device according to claim 1, the driving circuit comprising:
a first inverter, an input terminal of the first inverter receiving the control signal; and
a second inverter, an input terminal of the second inverter being electrically connected to an output terminal of the first inverter, an output terminal of the second inverter being configured to generate the driving signal.

7. The electrostatic discharge protection device according to claim 6, the second inverter comprising:
a PMOS transistor, a source of the PMOS transistor being electrically connected to the first line, a gate of the PMOS transistor being electrically connected to the output terminal of the first inverter, a drain of the PMOS transistor being configured to generate the driving signal; and
a resistor electrically connected between the drain of the PMOS transistor and the second line.

8. The electrostatic discharge protection device according to claim 6, the clamping circuit comprising:
an NMOS transistor, a drain of the NMOS transistor being electrically connected to the first line, a gate of the NMOS transistor being electrically connected to the output terminal of the second inverter, a source of the NMOS transistor being electrically connected to the second line.

9. The electrostatic discharge protection device according to claim 1, the driving circuit comprising:
odd-numbered inverters connected in series between the node and the clamping circuit, a first inverter among the inverters receiving the control signal, a last inverter among the inverters generating the driving signal.

10. The electrostatic discharge protection device according to claim 9, the clamping circuit comprising:
a PMOS transistor, a source of the PMOS transistor being electrically connected to the first line, a gate of the PMOS transistor being electrically connected to an output terminal of the last inverter of the inverters, a drain of the PMOS transistor being electrically connected to the second line.

11. An electrostatic discharge protection device comprising:
a plurality of voltage drop elements connected in series between a first line and a node;
an impedance element electrically connected between the node and a second line;
a driving circuit amplifying a control signal from the node and accordingly generating a driving signal;
a clamping circuit determining whether to generate a discharging path between the first line and the second line according to the driving signal; and
a latch circuit electrically connected to the node and the driving circuit, wherein if the voltage drop elements are turned on, the latch circuit latches the control signal to a predetermined level, such that the clamping circuit generates the discharge path.

12. The electrostatic discharge protection device according to claim 11, wherein the driving circuit receives the control signal through a first inverter, and the latch circuit comprises:
a PMOS transistor, a source of the PMOS transistor being electrically connected to the first line, a gate of the PMOS transistor being electrically connected to an output terminal of the first inverter, a drain of the PMOS transistor being electrically connected to an input terminal of the first inverter; and
a capacitor, a first terminal of the capacitor being electrically connected to the drain of the PMOS transistor, a second terminal of the capacitor being electrically connected to the second line.

13. The electrostatic discharge protection device according to claim 12, wherein the driving circuit comprises the first inverter and a second inverter, the input terminal of the first inverter is electrically connected to the node, an input terminal of the second inverter is electrically connected to the output terminal of the first inverter, and an output terminal of the second inverter is configured to generate the driving signal.

14. The electrostatic discharge protection device according to claim 13, the second inverter comprising:
a PMOS transistor, a source of the PMOS transistor being electrically connected to the first line, a gate of the PMOS transistor being electrically connected to the output terminal of the first inverter, a drain of the PMOS transistor being configured to generate the driving signal; and
a resistor electrically connected between the drain of the PMOS transistor and the second line.

15. The electrostatic discharge protection device according to claim 13, the clamping circuit comprising:
an NMOS transistor, a drain of the NMOS transistor being electrically connected to the first line, a gate of the NMOS transistor being electrically connected to the output terminal of the second inverter, a source of the NMOS transistor being electrically connected to the second line.

16. The electrostatic discharge protection device according to claim 11, wherein each of the voltage drop elements is constituted by a PMOS transistor, a source of the PMOS transistor is electrically connected to the first line, and a gate and a drain of the PMOS transistor are electrically connected to the node.

17. The electrostatic discharge protection device according to claim 11, wherein each of the voltage drop elements is constituted by a diode, an anode of the diode is electrically connected to the first line, and a cathode of the diode is electrically connected to the node.
